(19) United States
(12) Patent Application Publication
(10) Pub. No.: US 2007/0099158 A1
(43) Pub. Date: May 3, 2007

(54) Literacy/numeracy development method and apparatus

(76) Inventors: Paul David Moran, Auckland (NZ); Tracey Janine Moran, Auckland (NZ)

Correspondence Address: JACOBSON HOLMAN PLLC, 400 SEVENTH STREET N.W., SUITE 600, WASHINGTON, DC, 20004, US

(21) Appl. No.: 11/589,135

(22) Filed: Oct. 30, 2006

Related U.S. Application Data
(63) Continuation-in-part of application No. PCT/NZ05/00083, filed on Apr. 27, 2005.

(30) Foreign Application Priority Data
Apr. 28, 2004 (NZ) NZ532645

(51) Int. Cl. G09B 19/00

(52) U.S. Cl. 434/156

(57) ABSTRACT

A game or educational apparatus is described, the game or educational apparatus comprising or including a support frame having a plurality of locators. The game or apparatus further including a changeable sheet having a plurality of primary indicia forming a primary indicia set. In use the sheet underlying the support frame and each indicia of the primary indicia set associated or associable with one locator of the plurality of locators. The game or apparatus further including a plurality of pieces forming a set of pieces. Each piece of the set of pieces having secondary indicia uniquely or near uniquely being associable with one indicia of the primary indicia set.

### TECHNICAL FIELD

The present invention relates to a novel literacy development method teaching literacy and numeracy in a first or further language to children and adults alike. More particularly but not exclusively it relates to a novel literacy/numeracy development method, and associated educational apparatus which facilitates the teaching of literacy and numeracy according to the method.

### BACKGROUND OF THE INVENTION

“Literacy” encompasses not only reading; it also includes listening, speaking, reading, writing, spelling and numeracy skills, all of which are learnt interdependently. Given that all children in developed (and most developing) countries must have these skills in order to function effectively in society, the need to develop these skills is clear. A high level of literacy is a key enabler for improvements in social and economic standards.

Taking New Zealand for example, relative to other OECD countries, the national literacy abilities are slipping. Four major surveys of education were carried out internationally between 1999 and 2003 comparing the educational achievement of the OECD countries. Before the 1980s, New Zealand was ranked first in the world in terms of literacy. Now, according to these findings, NZ has slipped to 13th. While 19 per cent of 15-year-olds (11,000 of 59,000) are performing well, according to fixed international standards, 50 per cent of New Zealanders (and 72 per cent of Maori and Pacific Islanders) perform at the two lowest levels in an international literacy study. At the adult level, a 1996 International Adult Literacy Survey (aged 16 to 65) found one in five New Zealanders had very poor literacy skills.

Although New Zealand may be slipping on a relative basis, on an absolute basis, other countries are experiencing literacy problems also. In the UK for example, 50 per cent of all children fail to learn to read in their first year of school, and 30 per cent of all children develop learning difficulties at some point while learning to read, with dyslexia contributing 4 per cent to the total. In the US, 25 per cent of all first-year college (university) students need remedial classes in the three R's (reading, writing and arithmetic). Researchers in the US joke that children learn computing at elementary school and literacy at college. Low rates of literacy appear to be a significant, international problem. According to UNESCO, 990 million people in the world are illiterate. The United Nations is attempting to address this issue through a campaign called ‘2003-2012, the Literacy Decade’.

Recent research has been questioning former-held beliefs about the strongest contributors to poor literacy levels. Research findings would tend to suggest that the solution to literacy problems lies in a combination of providing children with better primary school teachers (good qualifications, higher expectations and greater classroom discipline), along with better resources. However such an approach would provide an incomplete solution, one of the major reasons being that we believe literacy teaching begins before children are of a school-age and that parents and guardians could be the most effective literacy teachers, if only they knew how. We also strongly believe that most parents wish to maximise their child's learning potential, but parents do not have effective resources and methods at their disposal. We believe a truly effective literacy programme comprises all of the following elements.
Motivated parents: Parents need to be made aware that socio-economic status is irrelevant when it comes to a child's learning potential. Effective teaching requires one-on-one teaching for up to 30 minutes at a time, so parents must be committed to providing this time before a child attends primary school.
Simple, effective, proven methods: Very few parents would be up-to-date with the latest thinking and research as to which methods are the most effective for teaching literacy. Parents have to be able to trust that the resources and methods they are using have been shown to be effective and that they are simple for parents to use.
Culturally relevant: Resources must reflect the cultural background of the user. At a pre-school age, a child may have English as a second language. In this case, the foundation skills that need to be developed at a pre-school age must be developed in the strongest (native) language.
Fun: The importance of fun for both child and parent can not be underestimated. It is key to developing stamina, concentration, confidence and self-esteem, which are critical to learning.

The traditional school of literacy was known as the “whole word” school, where children were simply given books and required to memorise whole words in order to learn to read. Since the 1990s, this method has largely been deemed inadequate by many researchers, although some children can learn effectively by this method and proponents of it still exist. Since this time, the method of teaching phonics (or the sounds and the letter/s than make these sounds) has gained credibility and is now largely accepted as being superior to the whole word method. Books dedicated to the teaching of phonics exist today. More recently, a small number of researchers have highlighted the importance of oracy (listening and speaking) skills in reading abilities. In summary, there is a vast amount of research beyond whole word, phonics and oracy that claims to understand the key barriers to effective teaching of reading.

Analogous to literacy are modern trends in numeracy.

It is an object of the present invention to provide literacy and/or numeracy development methods and/or apparatus to facilitate literacy and/or numeracy development which deals with one or more of the abovementioned issues or which will at least provide the public with a useful choice.

Other or alternative objects are to provide game and/or educational apparatus (as packs thereof) able to assist literacy and/or numeracy development.

### SUMMARY OF THE INVENTION

In one aspect of the present invention consists in a game or educational apparatus comprising or including

a support frame having a plurality of locators;

a changeable sheet having a plurality of primary indicia forming a primary indicia set, in use said sheet underlying said support frame and each indicia of said primary indicia set associated or associable with one locator of said plurality of locators; and

a plurality of pieces forming a set of pieces, each piece of said set of pieces having secondary indicia uniquely or near uniquely associable with one indicia of said primary indicia set.

Preferably each locator of said plurality of locators is a unique shape compared to each other locator.

Preferably each piece of said set of pieces has a unique shape compared to each other piece.

Preferably each piece of said set of pieces has a correspondingly shaped locator.

Preferably including a plurality of changeable sheets, each sheet having a unique primary indicia set.

Preferably each said changeable sheet has a unique primary indicia set on each side of said sheet, said sheet being reversible.

Preferably the secondary indicia on each piece of said set of pieces is uniquely associable or near uniquely associable with one indicia of said plurality of primary indicia on more than one primary indicia set.

Preferably the secondary indicia on a said set of pieces form a secondary indicia set, said game or educational apparatus including a plurality of said set of pieces, each set having a unique secondary indicia set, each secondary indicia set associable with at least one primary indicia set.

Preferably the secondary indicia on said set of pieces forms a secondary indicia set and wherein the secondary indicia on a first side of said set of pieces forms a first secondary indicia set and the set of secondary indicia on the second side of said set of pieces forms a second secondary indicia set, each set of secondary indicia associable with at least one primary indicia set.

Preferably each secondary indicia is on and/or in a substrate capable of being handled and being uniquely or near uniquely positioned on and/or in its corresponding locator.

Preferably each locator is at least one of an upstand, protrusion, depression, hole, shape, silhouette, background and/or pattern onto and/or into which a substrate carrying only the or a corresponding secondary indicia appropriate for the primary indicia can be appropriately positioned.

Preferably each primary indicia is one or more of a picture, pictures, a letter, letters, a number, numbers, a symbol, symbols, an icon, icons, part of a word, a word, words and each secondary indicia is one or more of a picture, pictures, a letter, letters, a number, numbers, a symbol, symbols, an icon, icons, the remainder of or part of a word, a word, words or a translation of a word or words.

In another aspect the present invention consists in a method of literacy and/or numeracy development reliant upon a use of the game or educational apparatus as claimed in claim 1.

In another aspect the present invention consists in software implementing the educational game as above described.

In another aspect the present invention consists in software implementing the method of literacy and/or numeracy development as above described.

In another aspect the present invention consists in a kit for extending the game or educational apparatus as above described comprising or including:

a sheet having a plurality of primary indicia forming a primary indicia set, in use said sheet underlying said support frame and each indicia of said primary indicia set associated or associable with one locator of said plurality of locators; and

a plurality of pieces forming a set of pieces, each piece of said set of pieces having secondary indicia uniquely or near uniquely associable with one indicia of said primary indicia set.

Preferably said kit including a plurality of changeable sheets, each sheet having a unique primary indicia set.

Preferably each said changeable sheet has a unique primary indicia set on each side of said sheet, said sheet being reversible.

Preferably the secondary indicia on each piece of said set of pieces is uniquely associable or near uniquely associable with one indicia of said plurality of primary indicia on more than one primary indicia set.

Preferably the secondary indicia on a said set of pieces form a secondary indicia set, said game or educational apparatus including a plurality of said set of pieces, each set having a unique secondary indicia set, each secondary indicia set associable with at least one primary indicia set.

Preferably the secondary indicia on said set of pieces forms a secondary indicia set and wherein the secondary indicia on a first side of said set of pieces forms a first secondary indicia set and the set of secondary indicia on the second side of said set of pieces forms a second secondary indicia set, each set of secondary indicia associable with at least one primary indicia set.

Preferably each secondary indicia is on and/or in a substrate capable of being handled and being uniquely or near uniquely positioned on and/or in its corresponding locator.

In another aspect the present invention consists in a sheet for use with the game or apparatus as above described wherein said sheet has a plurality of primary indicia forming a primary indicia set, in use said sheet underlying said support frame of said apparatus and each indicia of said primary indicia set associated or associable with one locator of said plurality of locators.

Preferably each said sheet has a unique primary indicia set on each side of said sheet, said sheet being reversible.

Preferably said pieces forming a set of pieces, each piece of said set of pieces having secondary indicia uniquely or near uniquely associable with one indicia of said primary indicia set.

Preferably the secondary indicia on said set of pieces forms a secondary indicia set and wherein the secondary indicia on a first side of said set of pieces forms a first secondary indicia set and the set of secondary indicia on the second side of said set of pieces forms a second secondary indicia set, each set of secondary indicia associable with at least one primary indicia set.

In another aspect the present invention consists in a sheet and a plurality of pieces for use with the game or apparatus as above described wherein:

said sheet has a plurality of primary indicia forming a primary indicia set, in use said sheet underlying said support frame of said apparatus and each indicia of said primary indicia set associated or associable with one locator of said plurality of locators; and

said pieces forming a set of pieces, each piece of said set of pieces having secondary indicia uniquely or near uniquely associable with one indicia of said primary indicia set.

Preferably each said sheet has a unique primary indicia set on each side of said sheet, said sheet being reversible.

Preferably the secondary indicia on said set of pieces forms a secondary indicia set and wherein the secondary indicia on a first side of said set of pieces forms a first secondary indicia set and the set of secondary indicia on the second side of said set of pieces forms a second secondary indicia set, each set of secondary indicia associable with at least one primary indicia set.

In another aspect the present invention consists in a game or educational apparatus comprising or including

a substrate or support system for a set or plurality (“set”) of locators,

primary indicia associated or associable one to each locator of the substrate or support system, and

secondary indicia corresponding to each primary indicia and each uniquely or near uniquely being associable with the locator of the substrate or support system of its corresponding primary indicia.

Preferably said secondary indicia are associable only when not excluded by physical differentiation. Preferably each secondary indicia is uniquely associable owing to physical differentiation to a single locator.

Preferably wherein said physical differentiation is by means of a matching or fitting by at least one of the criteria of shape and/or background.

Preferably wherein each locator is part of any array of locators on or in a panel.

In one aspect that is preferred, each secondary indicia is on and/or in a substrate capable of being handled and being uniquely or near uniquely positioned on and/or in its corresponding locator.

Preferably each locator is at least one of an upstand, protrusion, depression, hole, shape, silhouette, background and/or pattern onto and/or into which a substrate carrying only the or a corresponding secondary indicia appropriate for the primary indicia can be appropriately positioned.

Preferably the plurality of locators is part of an array of locators in a panel and said primary indicia are a corresponding array carried on a substrate to be viewed under and/or in the panel.

Optionally, but preferably, the primary indicia are each part of an array on a sheet each adapted to underlie a locator of an array of locators in a panel or sheet.

Preferably wherein each locator is a unique shape in an array of shaped locators.

In preferred forms, each primary indicia is one or more of a picture, pictures, a letter, letters, a number, numbers, a symbol, symbols, an icon, icons, part of a word, a word, words and each secondary indicia is one or more of a picture, pictures, a letter, letters, a number, numbers, a symbol, symbols, an icon, icons, the remainder of or part of a word, a word, words or a translation of a word or words.

Alternatively, the support system for the set of locators is that of a computer display and the program controls the association permitted for each secondary indicia. The program will already have associated primary indicia with the set of locators.

Preferably each program generated primary indicia is one or more of a picture, pictures, a letter, letters, a number, numbers, a symbol, symbols, an icon, icons, part of a word, a word, words and each program generated secondary indicia is one or more of a picture, pictures, a letter, letters, a number, numbers a symbol, symbols, an icon, icons, the remainder of or part of a word, a word, words or a translation of a word or words.

In another aspect the invention is apparatus substantially as herein described with reference to any one or more of the accompanying drawings.

In still another aspect the invention is, in combination, apparatus previously defined, and at least one other set of primary indicia and another set or other sets of secondary indicia.

Preferably at least one additional set of secondary indicia is on the reverse sides of substrates carrying a first set of secondary indicia.

Preferably the combination is substantially as herein described with or without reference to any one or more of the accompanying drawings.

In yet another aspect the invention is a game or educational apparatus comprising or including

a substrate defining an array of locators each associated with primary indicia,

a substrate capable of being handled and each carrying a secondary indicia corresponding to a primary indicia and being adapted to be uniquely or near uniquely associated with the locator of said substrate of its corresponding primary indicia,

a complementary additional substrate of locators of the same or a different kind,

a container or sleeve,

wherein secondary indicia on said substrate of the array of primary indicia can be transferred by, firstly, an overlaying of said additional substrate on said substrate on locators and, secondly, inversion thereof and thereafter the additional substrate of locators with such transferred secondary indicia can be inserted in said container or sleeve.

Preferably the apparatus is substantially as herein described with reference to any one or more of the accompanying drawings.

In another aspect the invention is an apparatus of each or both of the preceding two paragraphs which gives rise to a combination of the present invention.

In still another aspect of the invention a method of literacy and/or numeracy development reliant upon a use of apparatus of the present invention.

In another aspect of the invention there is provided a method of developing literacy in a language in a student, according to a literacy development scheme, wherein the scheme has three stages, Stage 1, Stage 2 and Stage 3, the method comprising or including the steps of:
1. exposing the student to activities and/or tasks and/or experiences and/or materials designed to build a degree of competency in Stage 1, and
2. monitoring or assessing the student (on one or more occasions) until the student reaches level of competency in Stage 1, and then
3. exposing the student to activities and/or tasks and/or experiences and/or materials designed to build a degree of competenty in Stage 2, and
4. monitoring or assessing the student (on one or more occasions) until the student reaches a level of competency in Stage 2, then
5. exposing the student to activities and/or tasks and/or experiences and/or materials designed to build a degree of competency in Stage 3, wherein:
   A. Stage 1 encompasses, with respect to the language, listening, speaking, attentional and memory skills, and the knowledge of vocabulary; sounds and counting; and
   B. Stage 2 encompasses, with respect to the language, the skills of letter, blend and number recognition, handwriting and word building, and the knowledge of the alphabet, phonemes, numbers and sound-to-letter connections,
   C. Stage 3 encompasses, with respect to the language, the skills of common word recognition, spelling, rhyming and arithmetic, and the associated knowledge of common words, pronunciation, awareness of multiple spellings of sounds, and algebra.

Preferably the student is taught or guided according to the literary development scheme by an instructor.

Preferably the levels of competency required to move from Stage 1 to Stage 2 and from Stage 2 to Stage 3 are predetermined. Additionally or alternatively they are judged by the instructor.

Preferably there is a further step.
6. monitoring or assessing the student (on one or more occasions) until the student reaches a level of competency in Stage 3.

Preferably the language is English, or other languages based upon Roman, Greek or Cyrillic characters.

Preferably Stage 2 knowledge includes awareness of one or more of the 26 letters of the English alphabet and/or awareness of one or more of 45 English phonemes.

In an embodiment the method is implemented in a computer program or using an automated processing device.

Preferably the computer program or automated processing device includes the functionality of the instructor.

In a further embodiment there are provided tangible materials designed to build competency in Stage 1 and/or Stage 2 and/or Stage 3.

Preferably the steps of exposing the student to activities and/or tasks and/or experiences and/or materials designed to build a degree of competency in Stage 1 and/or 2 and/or 3 include employing
one or more first articles having first indicia thereon, and
one or more second articles having second indicia thereon,
   wherein there is a matching condition which may be satisfied between at least one first article and at least one second article.

Preferably, satisfaction of the matching condition is judged by the successful fitting of one first or second article into a slot adjacent to the second or first articles respectively. Additionally or alternatively, satisfaction of the matching condition is judged by the instructor.

Preferably when the step is the step of exposing the student to activities and/or tasks and/or experiences and/or materials designed to build a degree of competency in Stage 1
the first articles have pictorial indicia thereon, and
the second articles have indicia thereon in the form of words in the language which describe or name the pictorial indicia,
and the matching condition is satisfied by identification of the word which describes or names the corresponding pictorial indicia.

Preferably when the step is the step of exposing the student to activities and/or tasks and/or experiences and/or materials designed to build a degree of competency in Stage 2
the first articles have pictorial indicia thereon, and
the second articles have indicia thereon in the form of letters or groups of letters which comprise one or more of the phonemes of the names or description of the pictorial indicia,
and the matching condition is satisfied by identification of the letters or groups of letters which comprise one or more of the phonemes of the names or description of the pictorial indicia.

Preferably when the step is the step of exposing the student to activities and/or tasks and/or experiences and/or materials designed to build a degree of competency in Stage 3
the first articles have indicia thereon in the form of words or groups of letters, and
the second articles have indicia thereon in the form of words or groups of letters which
and the matching condition is satisfied by identification of:
   identical words, or
   rhyming words and/or pictures, or
   identical words in an additional language.

According to a further aspect of the invention there is provided apparatus for use with the above method of the invention comprising or including:
a) one or more first members bearing a plurality of primary indicia, and
b) a plurality of matching articles having secondary indicia,
   wherein the first member, by virtue of the nature of the primary indicia, is adapted for use in one or more stages of the literacy development scheme.

Preferably the apparatus further includes a panel having a plurality of slots, one or more of the slots being so located that when the panel is placed adjacent to the first member, at least one of the primary indicia is visible through at least one of the slots.

Preferably the number of slots is identical to the number of primary indicia and one primary indicia is visible through each one of the slots.

Preferably the plurality of slots are so shaped that:
none is identical to another;
each is identically shaped to one matching article; and
each is vertically symmetrical (about the vertical axis).

In a further aspect of the invention there is provided an apparatus for an educational aid consisting or comprising of:
1) a panel having one or more slots or locators (“slots”) therein,
2) a first member bearing one or more primary indicia
3) at least one piece bearing a secondary indicia,
   wherein the first member is placed so one or more primary indicia can be viewed through one or more of the slots of the panel,

the pre-determined rules of use including provisions whereby the user matches said secondary indicia to the primary indicia based on pre-accepted categories of matching.

Pre-accepted categories of matching are typified by the matching of pictures, words, letters and sounds based on a common causal link.

In a preferred form, cutouts of said board and said pieces are paired together as represented by an “indication of pairing”.

An “indication of pairing” may be in the form of a shape, number, colour or any other physical or visual manifestation that allows said pairing to be indicated.

Preferably each slot is of a unique shape, and corresponds to the matching piece.

Preferably the panel contains 26 slots.

Alternatively the panel contains 10 or 13 slots.

Preferably the pieces are distinguishable in regards to indicia.

In a preferred form, indicia of the sheet and the pieces are paired together as represented by an “indication of matching”.

An “indication of matching” may be in the form of a shape, letter, word, picture, number, colour or any other physical or visual manifestation that allows the matching to be indicated in accordance to the pre-accepted categories of matching.

In one form the method as described is implemented on a computer.

Preferably said educational aid has any one or more of the features previously defined in respect of any embodiments of the present invention.

In another aspect the present invention consists of a method of learning consisting or comprising of:
1) a panel having one or more slots therein,
2) a first member bearing first indicia

wherein the first member is placed so one or more first indicia can be viewed in one or more slots of the panel, and
3) at least one piece bearing a secondary indicia,
4) a sequence of use of said apparatus,
5) the pre-determined rules of use including provisions whereby:

the user matches the secondary indicia to the first indicia based on pre-accepted categories of matching.

Pre-accepted categories of matching are typified by the matching of pictures, words, letters, phonemes, numbers and sounds based on a common causal link.

In a preferred form, said pieces are paired to the slots as represented by an “indication of pairing”.

An “indication of pairing” may be in the form of a shape, number, colour or any other physical or visual manifestation that allows said pairing to be indicated.

Preferably each slot is of a location of a unique shape, and corresponds to the matching piece. It can be of any shape.

Preferably the panel contains 26 slots.

Alternatively the panel contains 10 or 13 slots.

Preferably the pieces are distinguishable in regards to indicia.

In a preferred form, indicia of the sheet and the pieces are paired together as represented by an “indication of matching”.

An “indication of matching” may be in the form of a shape, letter, word, picture, number, colour or any other physical or visual manifestation that allows said matching to be indicated in accordance to said pre-accepted categories of matching.

Preferable the first member includes indicia that are representative of:
a) pictures
b) words
c) letters
d) numbers

Preferably said sequence of use involves matching of the first member and/or piece indicia based on the following order of matching:
i) picture to words,
ii) word to picture,
iii) letter to picture,
iv) picture to letter,
v) letter to phonemes,
vi) letter/group of letters to sounds,
vii) pictures to pictures
viii) words to words
ix) numbers to pictures
x) pictures to numbers.

Preferably the educational aid has any one or more of the features previously defined in respect of any embodiments of the present invention.

In one embodiment the method as described is implemented on a computer.

A further aspect of the present invention consists of an apparatus for a literacy aid as aforementioned in conjunction with packaging and/or an instruction sheet, at least the packaging and/or instruction sheet including direction as to the method of use of the literacy apparatus.

In yet a further aspect the present invention consists in a computer conditioning software or software for the purpose of conditioning a computer for the playing of a game of a kind previously defined with respect to apparatus, the board and all forms of markers being replaced by displays to be presented on the computer.

In still another aspect the invention is a method of developing literacy in a language in a student according to a literacy development scheme, comprising or including the steps of:
a) facilitating a first degree of competency with respect to at least one of language, listening, speaking, attentional or memory skills, or knowledge of vocabulary, sounds or counting
b) monitoring or assessing the student (on one or more occasions) until the student reaches said first degree of competency,
c) facilitating a second degree of competency with respect to at least one of language, skills of letter, blend or number recognition, handwriting or word building, or knowledge of the alphabet, phonemes, sound-to-letter connections, or numbers
d) monitoring or assessing the student (on one or more occasions) until the student reaches said second level of competency,
e) facilitating a third degree of competency with respect to at least one of language, skills of common word recognition, spelling, rhyming or arithmetic, or the associated knowledge of common words, pronunciation, awareness of multiple spellings of sounds, or algebra.

Preferably said method is implemented in a computer program or using a automated processing device.

According to a further aspect of the invention there is provided a literacy development kit comprising or including:
a) a first member bearing a plurality of primary indicia, and
b) a plurality of matching articles each bearing one of a set of secondary indicia,
   wherein each of the plurality of matching articles can be matched to one of the primary indicia according to the secondary indicia thereon, according to a matching condition.

In one embodiment the primary indicia are pictorial indicia and the secondary indicia are corresponding written words in a first language (or vice versa), and the matching condition is satisfied by the matching of a pictorial indicia with its corresponding written word.

In another embodiment the primary indicia are pictorial indicia and the secondary indicia are corresponding written words in a first language describing the primary indicia (or vice versa), wherein the spelling of the written word will have one or more phonemes omitted and the matching condition is satisfied by the matching of a pictorial indicia with its corresponding written word despite the one or more omitted phonemes.

In another embodiment the primary indicia are written words in a first language, and the secondary indicia are written words in the first language or in an additional language (or vice versa), and the matching condition is satisfied by:
matching of identical primary indicia and secondary indicia, or
matching of primary indicia with rhyming secondary indicia, or
matching of primary indicia in a first language with corresponding secondary indicia in the additional language.

In another embodiment the primary indicia are pictorial indicia and the secondary indicia are pictorial indicia, and the matching condition is satisfied by the matching of the primary indicia with the secondary indicia.

Preferably, with respect to all embodiments, the kit further includes a panel having a plurality of slots, one or more of the slots being so located that when the panel is placed adjacent the first member, at least one of the primary indicia is visible through at least one of the slots.

Preferably the number of slots is identical to the number of primary indicia and one primary indicia is visible through each one of the slots.

Preferably the plurality of slots are so shaped that:
none is identical to another,
each is identically shaped to one matching article, and
each is vertically symmetrical in shape.

Preferably the kit further includes a housing adapted to retain the first member and simultaneously to hold the panel adjacent the first member so that the first indicia are visible through the slots of the panel.

According to a further aspect of the invention there is provided a literacy development kit substantially as herein described with reference to any one or more of the drawings.

According to a further aspect of the invention there is provided a board bearing one or more indicia for use with the kit of the invention and/or with the method of the invention.

According to a further aspect of the invention there is provided one or more articles bearing one or more indicia for use with the kit of the invention and/or with the method of the invention.

According to a further aspect of the invention there is provided a panel having one or more slots therein for use with the kit of the invention and/or with the method of the invention.

Definitions

As used herein “comprising” means “consisting only in” or “consisting at least in part in” (i.e. can mean “including”) and similarly for variations of “comprising”.

As used herein “student” includes, but is not restricted to, an adult or a child developing literacy in a language for the first time; an adult or child developing literacy in an additional language;

As used herein “board” includes a true board to any other substrate of the layout or grid (e.g. the ground, a computer screen, etc).

As used herein the term “and/or” means “and” or or

As used herein the term “s” following a noun means the plural or singular form of that noun as might be appropriate and not necessarily dependent on the syntax in which it is present as to which is meant.

As used herein a definition defined in a plural or singular form holds good for the opposite. i.e. the singular or plural form.

As used herein “instructor” includes but is not restricted to a person or other entity (such as a computer) which assists the student in development of literacy according to the literacy development scheme of the invention.

As used herein “phonemes” includes a unit of sound, or a unique sound represented by one to three letters than can not be derived from a combination of existing sounds (e.g. ‘sh’ is a phoneme that is not derived from ‘s’ and ‘h’, however ‘cr’ is a blend derived from ‘c’ and ‘r’).

### BRIEF DESCRIPTION OF THE DRAWINGS

The present invention will now be described with reference to the accompanying drawings in which:

FIG. 1 illustrates a Literacy/Numeracy Pyramid of the invention,

FIG. 2 is a perspective view of one language board of the invention having 10 slots,

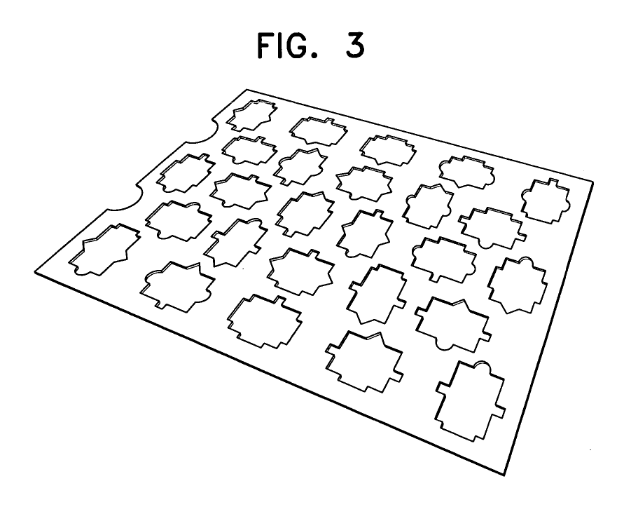

FIG. 3 is a perspective view of a second language board of the invention having 26 slots,

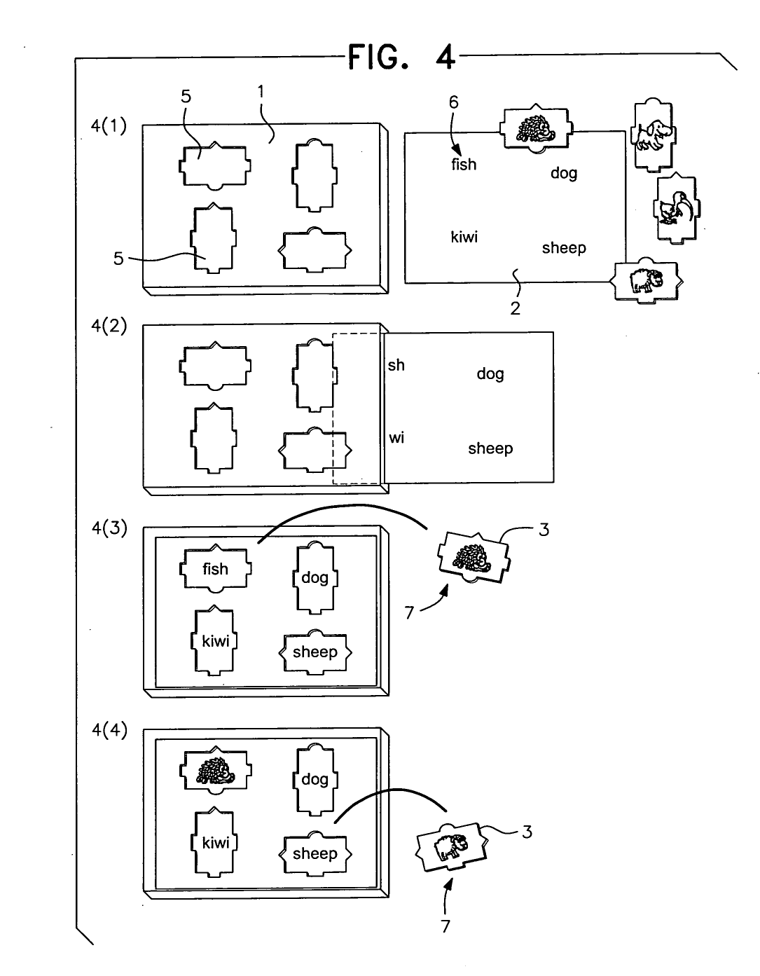

FIG. 4 illustrates example components of the apparatus of the Invention, FIG. 5 illustrates example components used for the three stages of the method of the invention, and

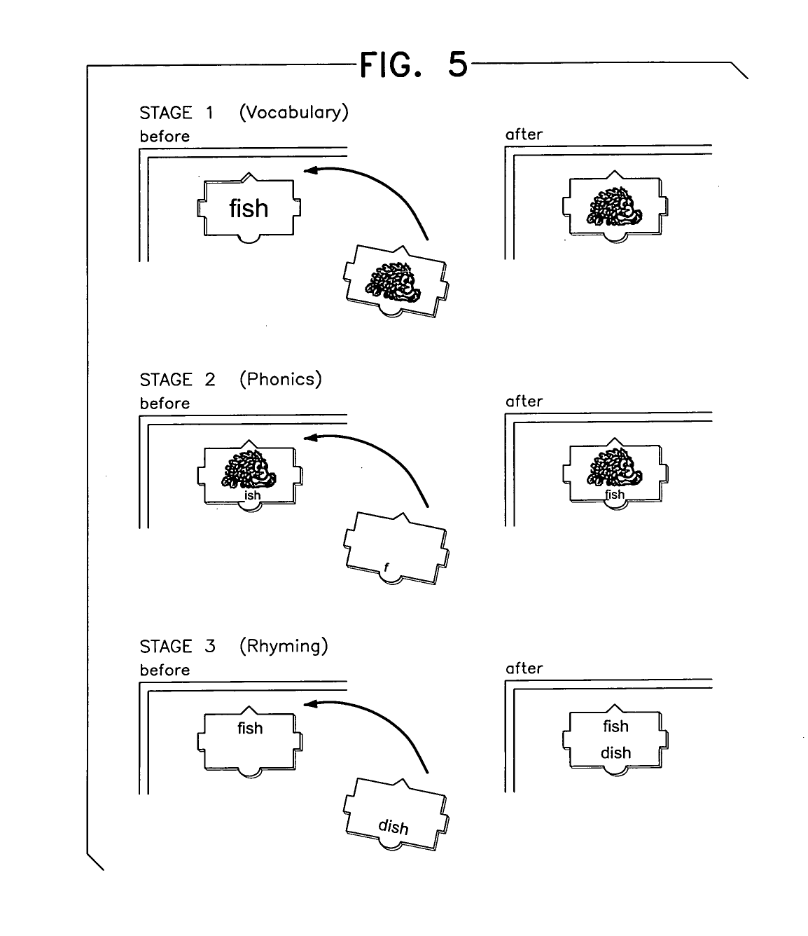

FIG. 6 shows in stages (6)1 to (6)4 a completed game, a further substrate, and a container or sleeve, the sequence showing how the extra substrate can be used to store the set of secondary indicia pieces.

### DETAILED DESCRIPTION

The teaching method, described herein as the Literacy/Numeracy Pyramid (hereinafter the “Litnum” Pyramid), builds upon what is known about literacy from research, such as teaching whole words, phonics and oracy, and upon our own teaching experience, but comprises three novel aspects. The first is that it combines literacy and numeracy development into a single, holistic, multi-lingual programme. The programme enlists a wide range of existing literacy knowledge, rather than focusing on one specific aspect, concentrating on-the ideas that have been shown to work in a classroom setting. The second is that the method distinguishes between developing skills and acquiring knowledge at each stage. Skill development and knowledge acquisition occur interdependently, i.e. skill development can not be obtained effectively without gaining knowledge and knowledge can not be gained effectively without developing skills. Finally, the method follows three stages in a specific order using a pyramid approach, whereby proficiency at the first stage is required before the second stage is attempted, and proficiency at the second is required before the attempting the third. The skills are cumulative, i.e. the skills learnt at the first stage are also employed at the second and third stage (and likewise the skills at the second stage are required for the third stage), allowing the method to be represented by a pyramid, hence the Litnum pyramid.

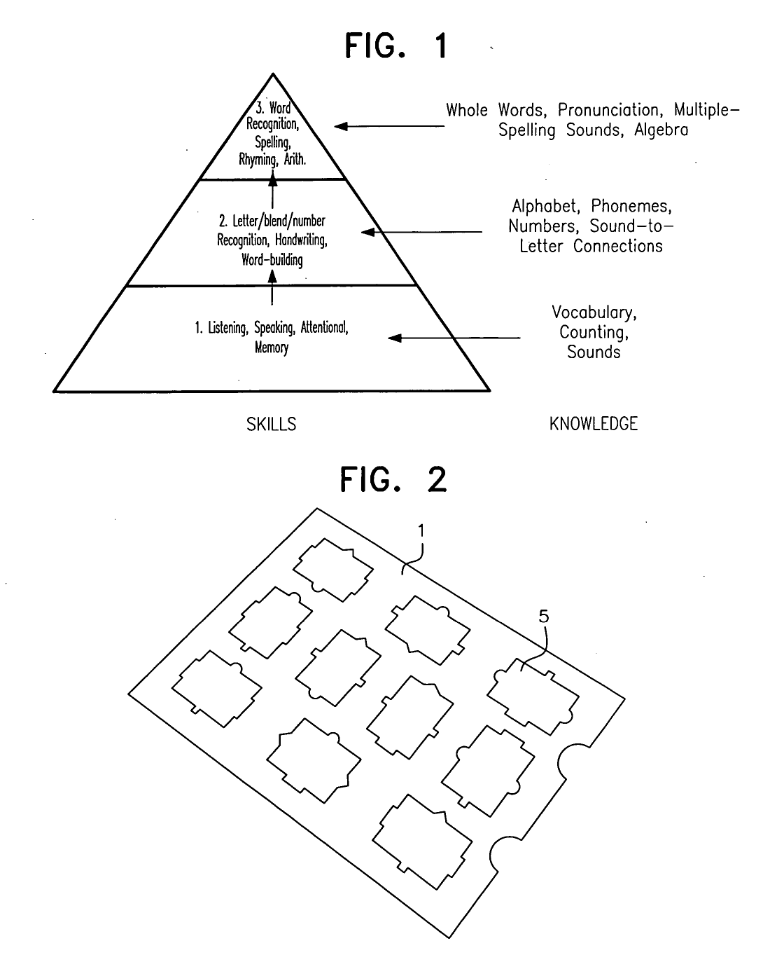

The novel method of the invention establishes three stages of literacy development. We call these three stages the “Litnum Pyramid”. The Litnum Pyramid is illustrated in FIG. 1.

The Litnum Pyramid (and hence the method of the invention) consists of the following three stages. It is important to note that the method involves the substantially simultaneous attainment of skills and knowledge. In the following description the method is generally described in relation to the English language. It will be appreciated that the method can be applied to other languages; the detail in relation to which the specifics (the number of phonemes for example) will differ.

Stage 1: Development of Listening, Speaking, Attentional and Memory Skills;

skills include listening, speaking, attentional and memory skills; associated knowledge relates to vocabulary, sounds and counting.
   Stage 2: Development of Letter/Blend Recognition, Handwriting and Word Building Skills;
skills include letter, letter blend and number recognition, handwriting and word building; associated knowledge relates to the alphabet, phonemes, sound-to-letter connections and numbers.

This stage deals with the student understanding the relationship between sounds or phonemes (in English, there are 45) and the concept that these can be represented as letters or groups of letters. The stage assists with the mapping between 26 letters and 45 different sounds. It also teaches that numbers can be represented by symbols and words.

Stage 3: Development of Common Word Recognition, Spelling, Rhyming and Arithmetic Skills.

Skills include common word recognition, spelling, rhyming and arithmetic; associated knowledge relates to common words, pronunciation, multiple-spelling sounds and algebra.

This stage deals with the understanding that the different sounds of Stage 2 maybe spelt in a number of different ways. Whole word recognition is important at this stage, and activities which reinforce this may be introduced. “Rhyming” for example, is appropriate at this stage. The basic mathematical concepts of addition, subtraction, multiplication and division are introduced and explained here.

Literacy Development Apparatus/Kit The preferred form of the apparatus of the invention takes the form of a kit. The strength of the kit is the inventive use of a number of features which allow for literacy development according to the method of the invention.

In particular, with reference to the above Stages of the Litnum Pyramid, the Apparatus/Kit will facilitate the following:

Stage 1: Development of Listening, Speaking, Attentional and Memory Skills;

Development of vocabulary—matching pictures with spoken (and written) words;
Introduction of counting—matching numbers to pictures illustrating those numbers
   Stage 2: Development of letter/blend recognition, handwriting and word building skills;
Matching letters of the alphabet with pictures/written words
Development of letter, letter blend and number recognition; understanding the relationship between sounds and letters. Phonemes are taught in the order that they are most easily understood, as follows; Matching in 3 stages, which links the sounds to the written letter and spoken letters;
   2a) the phoneme at the beginning of a word
   2b) the phoneme at the end of a word
   2c) blends at the beginnings of words
   2d) the phoneme in the middle of a word
   2e) vowels (short and long)
   2f) number symbols
      Stage 3: Development of Common Word Recognition, Spelling, Rhyming and Arithmetic Skills.
Skills include common word recognition, spelling, rhyming and arithmetic; associated knowledge relates to common words, pronunciation, multiple-spelling sounds and algebra.
Matching of different spellings of similar sounding words (such as rhyming words).
Investigation of the principles of addition, subtraction, multiplication and division, by matching calculations to the correct answers.
   Form of the Literacy Development Kit

The preferred form will be specifically discussed below. However, at a general level the kit includes a teaching sheet having a number of simple pictures or words drawn on it, and a language board with a number of cut-out sections or shapes (none being identical), which is designed to be superimposed over the teaching sheet. It can be held in place over the teaching sheet by virtue of a shell, housing or frame which will ideally take the form of a box. When placed over the teaching sheet the individual pictures or words will be visible through the cut out sections.

The kit also includes a number of puzzle pieces which will also have marked upon them picture, or words or other markings. These pieces will, depending upon which stage of the scheme is being addressed, match in some way the underlying picture or word of the teaching sheet according to a matching condition, whilst simultaneously fitting the overlying cut out section from the teaching sheet. The “fit” will be like that of a jigsaw puzzle in nature.

The matching condition may be:
picture to picture
full word to picture
part word to picture
word to word
number to picture
picture to number.
   as is discussed below.
   The Preferred Form of the Apparatus and its Method of Use Below we briefly describe the two key components that comprise the method and kit of the invention—the physical description and the learning method. It will be appreciated that this is just one form of the apparatus of the invention and one mode of use. Within the scope of the invention there may be many other physical forms that the apparatus may take and many other variations of use.
   Physical Description

The preferred form of the kit of the invention consists of a plastic, transparent, (ideally, but not limited to) ‘A3’-sized language board with (ideally, but not limited to) between 10 and 26, uniquely-shaped, ‘jigsaw’-shaped holes that are themselves vertically symmetrical. For each ‘hole’ in the board, there is a correspondingly shaped piece that fits into the hole. Owing to the vertically symmetrical shape of the holes and shapes, the reverse-side of the shapes also fits in the holes. A replaceable, plastic-laminated, paper sheet can be placed into position underneath the language board using an attachment mechanism (such as clips, Velcro or grooves). Each sheet contains either cartoon-images, words, letters, numbers, blends of letters or parts of words, which are arranged into the positions corresponding to the holes in the board directly above. The plastic piece, corresponding to the hole above the image/word/letter etc on the sheet has the corresponding image/word/letter attached to it. For example, where the sheet contains the word ‘horse’, the plastic piece corresponding to the hole above the word horse would have attached a picture of a horse.

In the preferred form sheets may be separated into two to five sections/zones using different background colours, enabling the kit of the invention to be used in multi-player bingo games if so desired, as well enabling a reduction the number of pieces to be used at any one time by using a defined zone only. Further, a whole range of different languages can be catered for, by having different sheets (without having to change the pieces). Likewise, a range of skills such as learning vocabulary, the alphabet, blends, spelling, rhyming, arithmetic and comprehension can be taught by changing the sheet and corresponding pieces. Sheets can be double-sided to increase the body of learning. In summary, there is one template panel (the language board) with a number of cut-outs, but multiple sheets and corresponding pieces, and therefore, multiple languages and skill sets can be taught.

Method of Use

The learning method comprises the use of the sheets and corresponding pieces in a structured, systematic way having regard to the Litnum Pyramid. An instructor (parent, teacher, guardian, caregiver or even other child) uses a (possibly multi-lingual) instruction manual to follow each stage. Firstly, a child places a particular sheet into position in the box. When questioned by the instructor, the child searches for the correct piece to answer the question (for example, “which animal is a horse?”). The child then places the piece in the corresponding position in the box (in this case, above the word ‘horse’), as directed by the instructor. If the answer is not correct, then the piece will not fit, given that all the holes in the box are different from each other.

This method is the basic working mechanism of the kit of the invention. However, the learning method follows three particular stages in order, using the ‘Litnum Pyramid’. FIG. 1, the schematic of the Litnum Pyramid illustrates how skills are developed at the same time that knowledge associated is gained. In other words, skill development and knowledge accumulation are gained in harmony with each other. Also, the most basic skills (listening, speaking, attentional and memory) underpin the more complex skills (letter/blend/number recognition, handwriting and word-building), which underpin the even more complex skills (word recognition, spelling, rhyming and arithmetic). It is essential in the method of the invention that skills in the lower level be mastered before those in the layer above.

The Litnum Pyramid in Conjunction with the Kit of the Invention

The following description (with a child as the student) describes the method of the invention in greater detail when performed in conjunction with the kit.

Stage 1 of the Litnum Pyramid

This first stage uses selected vocabulary to develop listening, speaking, attentional and memory skills. Carefully chosen categories of vocabulary are written on the sheets of the kit. In one versatile form of the kit the words may be on the sheets in two languages (for example English as the ‘anchor’ language, and one other—but anchor languages can be varied), being both appropriate for the learning of English as a first language and also an additional language.

Upon request, a child matches the instructor's question (based on a word in the hole) with the corresponding picture of the word on a piece and places it in the hole pointed to by the instructor.

Bingo can also be played with multiple children per apparatus by matching a picture on a piece to that picture in a -hole. The core areas of vocabulary may be (but are not limited to) bodyparts, clothes, at home, in the garden, food, in town, animals, at school/nursery, activities, position and numbers/colours/shapes. These eleven areas cover the core vocabulary that would likely be used at home, in town and importantly, at school. However, other culturally-specific areas of vocabulary may also be covered to ensure that the material a child is learning is relevant. (These pieces may optionally all have the word written on the reverse-side in the anchor language, enabling these pieces to be used for practice in stage 3).

Examples of words vocabulary which may be relevant in stage one are provided in Table 1.

TABLE 1

| Body | | | | | | At school/ | | | Nos, |
|---|---|---|---|---|---|---|---|---|---|
| parts | Clothes | At home | Food | In town | Animals | nursery | Activities | Position | colours |
| ankle | boots | bath | Apple | aeroplane | bear | bars | build | above | 1 |
| Arm | button | bed | Apricot | bicycle | camel | blackboard | catch | behind | 2 |
| back | coat | bowl | Banana | Book | cat | book | clap | below | 3 |
| bottom | dress | chair | Bread | Bus | cow | brush | cry | beside | 4 |
| chest | gloves | cup | Butter | Car | dog | chair | draw | between | 5 |
| Chin | hat | door | Carrot | church | duck | chalk | give | bottom | 6 |
| Ear | helmet | drawers | Coconut | crane | elephant | climbing | hop | close | 7 |
| | | | | | | frame | | | |
| elbow | jacket | floor | Fish | dentist | fish | computer | jump | come | 8 |
| Eye | jandals | fork | Egg | digger | giraffe | crayon | kick | down | 9 |
| finger | jumper | glass | Grapes | doctor | goat | desk | listen | enter | 10 |
| foot | laces | knife | ice cream | fire | guinea | exercise | look | exit | 11 |
| | | | | engine | pig | book | | | |
| Hair | mittens | ladder | kiwi fruit | fireman | hippo | marker | pull | go | 12 |
| head | necklace | phone | Lettuce | helicopter | horse | net | push | in front | red |
| knee | pants | plate | Lollies | magazine | kiwi | paint | ride | inside | orange |
| Leg | scarf | pots | Meat | motorbike | lion | paper | run | left | yellow |

The vocabulary base can also be extended by introducing specific knowledge categories that extend a child's knowledge base, such as the ‘homes of animals’ (matching a picture of a nest on the sheet to that of a bird on a piece). What is most important to the method of the invention is that a child masters these listening, speaking, attentional and memory skills through gaining vocabulary, before attempting to learn the elements of the later stages. For older or more capable children, the kit of the invention can be used to demonstrate whether or not a child has developed these skills by measuring how quickly a set of pieces can be completed and for how long the child can work on the kit of the invention before losing focus. If a child can demonstrate solid listening, speaking, attentional and memory skills, then that child can move onto the next stage.

Stage 2 of the Litnum Pyramid

The second stage teaches letter, letter blend and number recognition, handwriting and word-building by making the crucial connection between the sounds children already know how to make and the letter(s) that correspond(s) to those sounds, as well as the symbols that represent the number when they count.

Dealing with the English language as an example, it has 26 letters, 45 unique sounds (phonemes e.g. th, sh) and many ways of writing those sounds. Stage 2 gives examples of the spelling of almost all of those sounds (a few are ignored due to their infrequent use in English). In this way, a child is introduced to the concept that a word can be ‘built’. In a preferred form of the kit (but it is not restricted to this) there are eight sheets in Stage 2, an alphabet sheet and six phoneme sheets and a number sheet. The alphabet is taught by asking a child to find the letter on a piece that corresponds to the starting sound of an object in a hole (on the sheet), for example, “can you find the letter that a horse starts with?”, requiring the child to find the piece with ‘Hh’ written on it. Alternately, the reverse sides of the alphabet sheet and pieces can be used to match the reverse, i.e. find an object on a piece that begins with letter in a hole (on the sheet). Likewise for the teaching of numbers, children are asked to find the symbol of a number that matches the corresponding picture that details the corresponding number of objects (e.g. the number ‘8’ is matched to a picture containing eight apples), and vice versa.

To teach word-building, a child is presented with a sheet that contains pictures of objects with the corresponding word written beneath, but with a letter (or blend of letters) missing, where the child is asked to find the corresponding missing letter(s) on a piece. The order of teaching the phonemes is important, from easy to difficult, namely: initial phoneme in a word; ending phoneme; and

middle phoneme. In Stage 2, almost all the unique phonemes (45) are covered (but not all spelling variations).

Table 2 provides an example of phonemes

TABLE 2

| Phoneme | First Phoneme | Last Phoneme | Middle Phoneme |
|---|---|---|---|
| B | Bear | grub | rabbit |
| D | Digger | | ladder |
| G | goose | pig | |
| H | Hat | — | — |
| L | Leaf | seal | |
| M | Moth | swim | |
| N | Nuts | lion | |
| P | Pencil | sheep | |
| R | Run | car | carrot |
| T | Toe | goat | |
| Y | | — | crayon |
| | Think | moth | — |
| | — | — | mother |

In an optional form the sheet that contains the letters of the alphabet can also be used as a tracing sheet to teach handwriting, where the letters or numbers are hollow but with directional arrows contained within to allow a pen to follow the lines that make up the letter or number.

Stage 3 of the Litnum Pyramid

This stage builds on Stage 2 by teaching the various spellings of the 45 phonemes. It also introduces the concept of whole word recognition and spelling of the more common ‘sight words’, uses rhyming words to introduce the concept of rhyme and introduces basic arithmetic. To teach various spellings, the concept is analogous to that in Stage 2, where a child is asked to find a letter or group of letters on a piece to complete the word in a hole (on the sheet). Words are arranged into groups of the same sound (e.g. ur, ir, er, ear, or) to make the comparisons between the different spellings apparent upon completion. For common sight words, a child matches the word in the hole with that on a piece.

For rhyming, a child first matches pictures of objects on a sheet with pictures of objects on pieces that rhyme (e.g. matching a ‘cat’ on the sheet with a ‘hat’ on a piece). Once the concept of picture rhyming is understood, the child then uses the reverse side of the same sheet and pieces to match the actual words that rhyme (instead of the pictures). For arithmetic, a child is asked to match an answer on a piece in the form of a number (say ‘5’) to a calculation on the sheet (say ‘2+3’). Alternatively, objects that represent these numbers (5 oranges) can be used either in addition, or separately on the reverse side of the sheet and piece (allowing interchangeable use given that the shapes are vertically symmetrical).

In the preferred kit, five phoneme sheets have been developed for Stage 3, with two common sight word sheets, two rhyming sheets and two arithmetic sheets. Once reading has been mastered at a basic level, the pieces in Stage 1 can be used for practice. Owing to the vertically symmetrical shape of the pieces and having the word written on the reverse-side of the picture pieces, a word piece can be matched against a picture in the hole (on the sheet).

New knowledge categories can be introduced which make the concept of reading whole words fun and educational, for example, matching the name of a country written in a hole (on the sheet) to the capital of that country written on a piece, the flag of a country to the country, name of a baby animal to the animal (e.g. kangaroo, joey), male/female animals (e.g. pig and sow), animal homes (e.g. rabbit and warren) etc.

Table 3 provides examples of words and pictures which may be used in Stage 3

TABLE 3

| Rhyme/similar | | | | | | |
|---|---|---|---|---|---|---|
| sounds | Picture | Word 2 | Word 3 | Word 4 | Word 5 | Word 6 |
| E | bed | bread | said | | | |
| Oa | boat | bone | grow | toe | go | dough |
| Oo | book | put | could | wolf | pull | |
| I | big | cylinder | | | | |

In the preferred form the kit has the following features

| Attributes | Benefits to the student |
|---|---|
| Tactile | Attention to learning maintained throughout, |
| | kinaesthetic as well as visual and oral learning, which |
| | is essential for some learners |
| Interactive | Develops core literacy skills, builds child/parent |
| | attachment |
| Puzzle-based | The child ‘discovers’ the answer, learning is paced and |
| | highly focused on the task at hand |
| Multi-lingual | Attractive to a variety of cultures, can be used to teach |
| | basic vocabulary in other languages in addition to |
| | English |
| Comprehensive, | Teaches foundation skills first, working through to the |
| step-by-step | full range of more complex word-building skills |
| Fun | Improves concentration skills effortlessly, for child and |
| | parent |

Discussion of Attributes of the Kit

a) Tactility
In the preferred form the kit of the invention involves handling of jigsaw-shaped pieces by the child at all times. Children will find the shapes interesting and because they are holding the learning material nearly constantly, their attention to learning is maintained throughout. As we develop from a young age, we naturally begin to learn kinesthetically (through touch), then visually, followed by aurally. The use of physical pieces means that all three learning styles (kinesthetic, visual and aural) are taking place simultaneously. This is particularly useful for boys who have often been observed to learn in a more ‘tactile’ fashion, and can struggle to learn effectively in classroom settings that place more emphasis on aural teaching, followed by visual methods.

b) Interactive
The learning method involves the child matching a jigsaw-shaped piece showing the correct answer (picture/letter/word) to a question on a replaceable sheet (underneath a corresponding hole in the box), as instructed by a parent or teacher. As the piece is placed in the correct position, the child says the answer, followed by the instructor. Such interactivity develops the foundation skills of listening, speaking and maintaining attention, without which, it is extremely difficult for a child to learn to read. The child also gets pleasure from successfully completing each instruction, along with positive reinforcement from the instructor. Spending 30 minutes a day working interactively with a child would also help develop a positive relationship between the child and parent/guardian/teacher, associated with a host of social, emotional and intellectual benefits.

c) Puzzle-based
Since the learning activity involves matching a unique, jigsaw-shaped piece to a corresponding hole in the box, a child knows when he/she has the right answer; the piece ‘fits’. Working one piece at a time enables teaching of very specific elements of learning, which takes place in a paced, non-rote fashion. This is particularly important for teaching phonics and word-building, where a child must make the connection between the sound and its letter(s) using a picture as a prompt. Given the finite number of holes and pieces, the device can also be used as a literacy testing device, simply by measuring the time it takes a child to complete the entire puzzle.

d) Multi-lingual
The sheets that accompany the box are (in a preferred embodiment) written in multiple languages (although an anchor language, initially English, can always be present). For children from non-English speaking backgrounds (NESB), it is important that a child first develops a competence in his/her first language. Our experience of teaching primary school children indicates that an English vocabulary is most effectively taught to those NESB students that have the corresponding vocabulary in their first language. Also, material that is culturally familiar to a child is more likely to engender their interest through the relevance of the material.

e) Comprehensive, step-by-step skill development
The kit of the invention uses a simple step-by-step pyramid method that parents and teachers will easily be able to follow. The instruction manual, printed in multiple languages, will enable parents with relatively low English-speaking abilities to follow the method. The step-by-step pyramid method to develop the key skills of literacy, is taught in a very important order: firstly, listening, speaking, attentional and memory skills through teaching native language vocabulary, followed by English vocabulary (for NESB children); secondly, letter, blend and number recognition, handwriting and word-building through teaching the alphabet, numbers, phonemes and sound-to-letter connections; and thirdly word recognition, spelling, rhyming and arithmetic through teaching common sight words, pronunciation, multiple-spelling sounds and basic algebra.

f) Fun
The kit of the invention comprises cartoon-based drawings and interestingly shaped pieces which are fun for children to work with. Making educational products fun is the key to boosting concentration skills which are almost always lacking in children that are having difficulty learning to read.
   Internet/Computer Applications of the Invention

As will be clear to one skilled in the art, the method of the invention may also be enacted by computer rather than in the physical form described above. The computer may simulate the activities or matching experiences described above and the entire literacy development method may take place at a keyboard. It will also be clear to those skilled in the art that the method and application may be of a download form or alternatively obtained via portable media such as CD or DVD.

Learning an Additional Language

The method of the invention is predominantly discussed above in respect of the teaching of literacy in English to a student. Clearly the method has application in other languages than English, such as (for the New Zealand market) Maori, Samoan, German and Mandarin for example. This includes the teaching of literacy in a variety of languages as a first language to a child or alternatively when a student is already literate in a first language (the anchoring language) it includes teaching literacy in an additional language.

Product Description

The product comprises four components: substrate or support system for the locators (“frame”) (reference 1 in drawings); sheet (2); pieces (3); and storage container (4). The locators are designated as 5, the primary indicia as 6 and the secondary indicia as 7. The complementary additional substrate locators are on substrate 8.

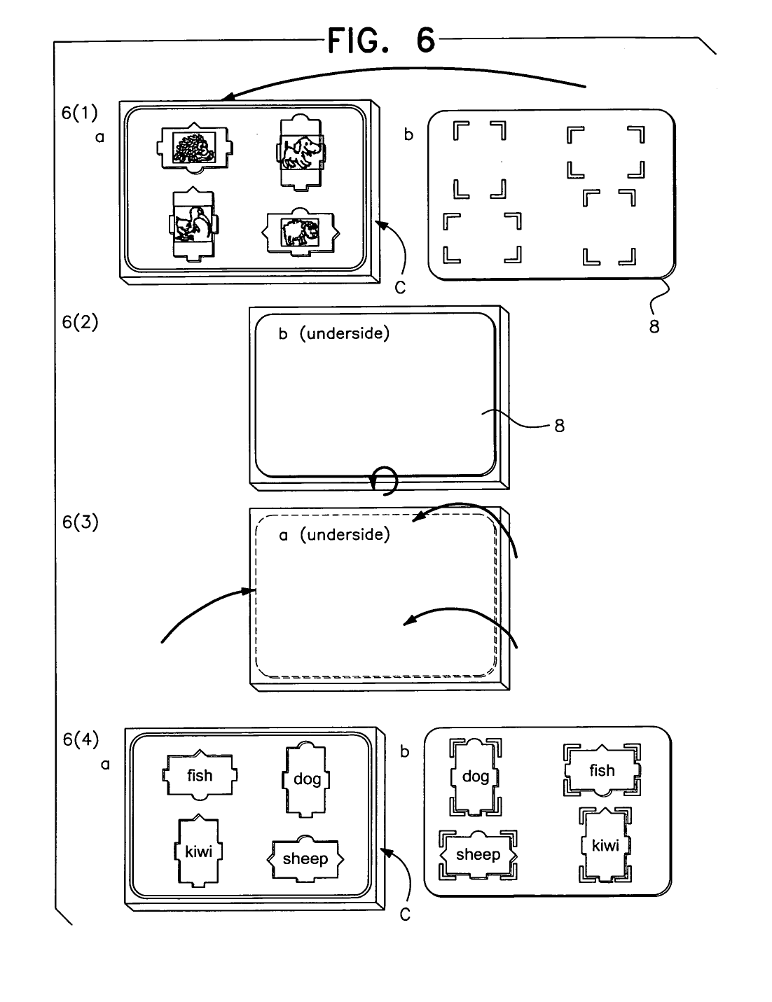

The images of FIG. 5 provide a schematic view of the basic workings of the apparatus, as well as a demonstration of the teaching at various levels. For simplicity, only 4 holes are shown in the diagrams, whereas the preferred form of the product actually contains 26 holes (to enable teaching of the letters of the alphabet).
Frame. The frame itself is composed of two components: a brightly coloured tray made of solid plastic, slightly bigger than an A3-sized page; and a transparent, hard plastic plate with 26 uniquely-shaped pieces moulded into it. The clear plate is slightly smaller than the backing board and is held within the confines of the tray via a ‘clipped fit’. Construction will be extremely sturdy, with the tray made from a very durable plastic (SAN), while the top plate will be constructed from polycarbonate, which is extremely durable.
Sheet. The sheet consists of a laminated A3-sized sheet, printed (usually) on both sides. The sheet contains either a number of words/letters/symbols, or matching pictures/words. The sheet is placed inside the frame by sliding the sheet into the gap between the plate and the tray. When placed in this way, the words, letters symbols or pictures line up precisely under the shaped-holes cut into the top plate. In the case of double-sided sheets, both sides can be utilised, one at a time. Changing the sheet enables a wide range of content to be covered using the same frame. The sheets can be written on directly, allowing additional languages to be covered using the same sheet.
Pieces. With each sheet comes a corresponding set of 26 plastic pieces. Each uniquely-shaped piece has an image that corresponds to one on the sheet. The shape of the piece will only fit the hole above the sheet that corresponds to the correct image (see diagram). The pieces will be transparent and made from durable, transparent plastic (SAN). The transparency allows for the opportunity in certain situations to see both the image on the piece and the sheet simultaneously (for example, for word-building), as well as allowing words to be directly written on them with a marker pen.
Storage container (see FIG. 6). This container has been specially designed so that the pieces can be put away quickly, using minimum space and in a way that identifies when a piece is missing (a four-piece puzzle is shown for simplicity). When all pieces are in their corresponding holes upon completion, the base of the container (FIG. 6, object lb below) is turned over and placed on top of the frame/pieces and sheet (FIG. 6, objects 1a and 1c respectively), via the corresponding groove in the frame. With the base and frame held together (FIG. 6, 2), they are turned upside-down allowing the pieces to fall into positions in the base with ‘holding protrusions’ (FIG. 6, 3). When the frame (FIG. 6, object 4a) and its enclosed sheet (FIG. 6, object 4c) are lifted off the container base, the pieces (now upside-down) remain lodged within the confines of the protrusions (FIG. 6, object 4b). In the final step (not shown), the sheet is removed from the frame, placed on top of the pieces in the container and the lid is placed upon the base for storage. The non-specific, ‘corner-shapes’ of the protrusions also allow pieces to be put away manually, for example when the puzzle has not been fully completed, into any position in the container base.

What is claimed is:

1. A game or educational apparatus comprising or including
a support frame having a plurality of locators;
a changeable sheet having a plurality of primary indicia forming a primary indicia set, in use said sheet underlying said support frame and each indicia of said primary indicia set associated or associable with one locator of said plurality of locators; and
a plurality of pieces forming a set of pieces, each piece of said set of pieces having secondary indicia uniquely or near uniquely associable with one indicia of said primary indicia set.

2. A game or educational apparatus as claimed in claim 1 wherein each locator of said plurality of locators is a unique shape compared to each other locator.

3. A game or educational apparatus as claimed in claim 2 wherein each piece of said set of pieces has a unique shape compared to each other piece.

4. A game or educational apparatus as claimed in claim 3 wherein each piece of said set of pieces has a correspondingly shaped locator.

5. A game or educational apparatus as claimed in claim 1 including a plurality of changeable sheets, each sheet having a unique primary indicia set.

6. A game or educational apparatus as claimed in claim 4 including a plurality of changeable sheets, each sheet having a unique primary indicia set.

7. A game or educational apparatus as claimed in claim 1 wherein each said changeable sheet has a unique primary indicia set on each side of said sheet, said sheet being reversible.

8. A game or educational apparatus as claimed in claim 6 wherein each said changeable sheet has a unique primary indicia set on each side of said sheet, said sheet being reversible.

9. A game or educational apparatus as claimed in claim 7 wherein the secondary indicia on each piece of said set of pieces is uniquely associable or near uniquely associable with one indicia of said plurality of primary indicia on more than one primary indicia set.

10. A game or educational apparatus as claimed in claim 8 wherein the secondary indicia on each piece of said set of pieces is uniquely associable or near uniquely associable with one indicia of said plurality of primary indicia on more than one primary indicia set.

11. A game or educational apparatus as claimed in claim 7 wherein the secondary indicia on a said set of pieces form a secondary indicia set, said game or educational apparatus including a plurality of said set of pieces, each set having a unique secondary indicia set, each secondary indicia set associable with at least one primary indicia set.

12. A game or educational apparatus as claimed in claim 9 wherein the secondary indicia on a said set of pieces form a secondary indicia set, said game or educational apparatus including a plurality of said set of pieces, each set having a unique secondary indicia set, each secondary indicia set associable with at least one primary indicia set.

13. A game or educational apparatus as claimed in claim 10 wherein the secondary indicia on a said set of pieces form a secondary indicia set, said game or educational apparatus including a plurality of said set of pieces, each set having a unique secondary indicia set, each secondary indicia set associable with at least one primary indicia set.

14. A game or educational apparatus as claimed in claim 1 wherein the secondary indicia on said set of pieces forms a secondary indicia set and wherein the secondary indicia on a first side of said set of pieces forms a first secondary indicia set and the set of secondary indicia on the second side of said set of pieces forms a second secondary indicia set, each set of secondary indicia associable with at least one primary indicia set.

15. A game or educational apparatus as claimed in claim 7 wherein the secondary indicia on said set of pieces forms a secondary indicia set and wherein the secondary indicia on a first side of said set of pieces forms a first secondary indicia set and the set of secondary indicia on the second side of said set of pieces forms a second secondary indicia set, each set of secondary indicia associable with at least one primary indicia set.

16. A game or educational apparatus as claimed in claim 12 wherein the secondary indicia on said set of pieces forms a secondary indicia set and wherein the secondary indicia on a first side of said set of pieces forms a first secondary indicia set and the set of secondary indicia on the second side of said set of pieces forms a second secondary indicia set, each set of secondary indicia associable with at least one primary indicia set.

17. A game or educational apparatus as claimed in claim 13 wherein the secondary indicia on said set of pieces forms a secondary indicia set and wherein the secondary indicia on a first side of said set of pieces forms a first secondary indicia set and the set of secondary indicia on the second side of said set of pieces forms a second secondary indicia set, each set of secondary indicia associable with at least one primary indicia set.

18. A game or educational apparatus as claimed in claim 1 wherein each secondary indicia is on and/or in a substrate capable of being handled and being uniquely or near uniquely positioned on and/or in its corresponding locator.

19. A game or educational apparatus as claimed in claim 1 wherein each locator is at least one of an upstand, protrusion, depression, hole, shape, silhouette, background and/or pattern onto and/or into which a substrate carrying only the or a corresponding secondary indicia appropriate for the primary indicia can be appropriately positioned.

20. A game or educational apparatus as claimed in claim 1 wherein each primary indicia is one or more of a picture, pictures, a letter, letters, a number, numbers, a symbol, symbols, an icon, icons, part of a word, a word, words and each secondary indicia is one or more of a picture, pictures, a letter, letters, a number, numbers, a symbol, symbols, an icon, icons, the remainder of or part of a word, a word, words or a translation of a word or words.

21. A method of literacy and/or numeracy development reliant upon a use of the game or educational apparatus as claimed in claim 1.

22. Software implementing the educational game as claimed in claim 1.

23. Software implementing the method of literacy and/or numeracy development as claimed in claim 21.

24. A kit for extending the game or educational apparatus as claimed in claim 1 comprising or including:
a sheet having a plurality of primary indicia forming a primary indicia set, in use said sheet underlying said support frame and each indicia of said primary indicia set associated or associable with one locator of said plurality of locators; and
a plurality of pieces forming a set of pieces, each piece of said set of pieces having secondary indicia uniquely or near uniquely associable with one indicia of said primary indicia set .

25. A kit for extending the game or educational apparatus as claimed in claim 24 including a plurality of changeable sheets, each sheet having a unique primary indicia set.

26. A kit for extending the game or educational apparatus as claimed in claim 25 wherein each said changeable sheet has a unique primary indicia set on each side of said sheet, said sheet being reversible.

27. A kit for extending the game or educational apparatus as claimed in claim 26 wherein the secondary indicia on each piece of said set of pieces is uniquely associable or near uniquely associable with one indicia of said plurality of primary indicia on more than one primary indicia set.

28. A kit for extending the game or educational apparatus as claimed in claim 27 wherein the secondary indicia on a said set of pieces form a secondary indicia set, said game or educational apparatus including a plurality of said set of pieces, each set having a unique secondary indicia set, each secondary indicia set associable with at least one primary indicia set.

29. A kit for extending the game or educational apparatus as claimed in claim 28 wherein the secondary indicia on said set of pieces forms a secondary indicia set and wherein the secondary indicia on a first side of said set of pieces forms a first secondary indicia set and the set of secondary indicia on the second side of said set of pieces forms a second secondary indicia set, each set of secondary indicia associable with at least one primary indicia set.

30. A kit for extending the game or educational apparatus as claimed in claim 29 wherein each secondary indicia is on and/or in a substrate capable of being handled and being uniquely or near uniquely positioned on and/or in its corresponding locator.

31. A sheet for use with the game or apparatus as claimed in claim 1 wherein said sheet has a plurality of primary indicia forming a primary indicia set, in use said sheet underlying said support frame of said apparatus and each indicia of said primary indicia set associated or associable with one locator of said plurality of locators.

32. A sheet as claimed in claim 31 wherein each said sheet has a unique primary indicia set on each side of said sheet, said sheet being reversible.

33. A plurality of pieces for use with the game or apparatus as claimed in claim 1 said pieces forming a set of pieces, each piece of said set of pieces having secondary indicia uniquely or near uniquely associable with one indicia of said primary indicia set.

34. A plurality of pieces as claimed in claim 33 wherein the secondary indicia on said set of pieces forms a secondary indicia set and wherein the secondary indicia on a first side of said set of pieces forms a first secondary indicia set and the set of secondary indicia on the second side of said set of pieces forms a second secondary indicia set, each set of secondary indicia associable with at least one primary indicia set.

35. A sheet and a plurality of pieces for use with the game or apparatus as claimed in claim 1 wherein:
said sheet has a plurality of primary indicia forming a primary indicia set, in use said sheet underlying said support frame of said apparatus and each indicia of said primary indicia set associated or associable with one locator of said plurality of locators; and
said pieces forming a set of pieces, each piece of said set of pieces having secondary indicia uniquely or near uniquely associable with one indicia of said primary indicia set.

36. A sheet and a plurality of pieces as claimed in claim 35 wherein each said sheet has a unique primary indicia set on each side of said sheet, said sheet being reversible.

37. A sheet and a plurality of pieces as claimed in claim 36 wherein the secondary indicia on said set of pieces forms a secondary indicia set and wherein the secondary indicia on a first side of said set of pieces forms a first secondary indicia set and the set of secondary indicia on the second side of said set of pieces forms a second secondary indicia set, each set of secondary indicia associable with at least one primary indicia set.
